(19) United States
(12) Patent Application Publication
(10) Pub. No.: US 2011/0133866 A1
(43) Pub. Date: Jun. 9, 2011

(54) COUPLER AND WIRELESS COMMUNICATION DEVICE USING COUPLER

(75) Inventors: Hiroyuki HOTTA, Tokyo (JP); Kouji Hayashi, Tokyo (JP)

(73) Assignee: KABUSHIKI KAISHA TOSHIBA, Tokyo (JP)

(21) Appl. No.: 12/787,528

(22) Filed: May 26, 2010

(30) Foreign Application Priority Data
Dec. 5, 2009 (JP) P2009-277102

(51) Int. Cl. H01P 1/04; H01P 5/00

(52) U.S. Cl. 333/24 R

(57) ABSTRACT

A coupler is provided on a printed board including a feeder circuit and a grounded circuit. The coupler includes a first line, a short-circuited line and an open-ended line. The first line has two ends. One of the ends is a feed point of the coupler connected to the feeder circuit, and another one of the ends is a node of the coupler. The short-circuited line is extended from the node to an end short-circuited to the grounded circuit. The open-ended line is extended from the node.

### CROSS REFERENCE TO RELATED APPLICATIONS

This application is based upon and claims the benefit of priority from the prior Japanese Patent Application No. 2009-277102 filed on Dec. 5, 2009; the entire contents of which are incorporated herein by reference.

### FIELD

The present invention relates to a coupler of a magnetic field coupling type.

### BACKGROUND

Close-proximity wireless communication means of a shorter communication range than that of short range wireless communication means such as Bluetooth (registered trademark) have been proposed in recent years. As one of such close-proximity wireless communication means, TransferJet (registered trademark) can be enumerated. TransferJet is a system which carries out communication by putting paired couplers for transmitting and receiving signals close to each other. A communication range of a few centimeters is assumed for TransferJet, having various advantages on aspects of security, etc. TransferJet features a high transmission rate (up to a few hundreds of Mbps), and is suited to a large volume of data transmission for multimedia content, etc.

An ordinary coupler of an electric field coupling type was disclosed. The coupler has an electrode and a stub for impedance matching. Further various resonance couplers were ordinarily disclosed. They are mainly used as filters.

It is difficult to make the coupler of the electric field coupling type thin as it needs to be thick enough to be provided with a stub. Meanwhile, if an ordinary resonance coupler is used as a coupler of a magnetic field coupling type for close-proximity wireless communication, and if one of the paired couplers is offset (centers of the both couplers do not meet) or rotated with respect to the other, the coupling can be weak so as to possibly degrade communication quality.

### BRIEF DESCRIPTION OF THE DRAWINGS

FIG. 1 illustrates exemplary shapes and arrangements of paired couplers.

FIG. 2 illustrates exemplary shapes and arrangements of paired couplers.

FIG. 3 illustrates exemplary shapes and arrangements of paired couplers.

FIG. 4 illustrates exemplary shapes and arrangements of paired couplers.

FIG. 5 is a graph for illustrating S21 parameters corresponding to FIGS. 1-4.

FIG. 6 illustrates exemplary shapes and arrangements of paired couplers.

FIG. 7 illustrates exemplary shapes and arrangements of paired couplers.

FIG. 8 is a graph for illustrating S21 parameters corresponding to FIGS. 1, 6 and 7.

FIG. 9 illustrates exemplary shapes and arrangements of paired couplers.

FIG. 10 illustrates exemplary shapes and arrangements of paired couplers.

FIG. 11 is a graph for illustrating S21 parameters corresponding to FIGS. 1, 9 and 10.

FIG. 12 illustrates exemplary shapes and arrangements of paired couplers.

FIG. 13 illustrates exemplary shapes and arrangements of paired couplers.

FIG. 14 is a graph for illustrating S21 parameters corresponding to FIGS. 6, 2, 12 and 13.

FIG. 15 illustrates an exemplary coupler of an embodiment.

FIG. 16 is a perspective view of the coupler and a grounded plate of the embodiment.

FIG. 17 illustrates a current distribution on the coupler shown in FIG. 15.

FIG. 18 schematically illustrates a coupling between paired couplers each having a same shape as shown in FIG. 15 and being offset to each other.

FIG. 19 illustrates conditions for simulating a coupling between paired couplers being offset to each other.

FIG. 20 illustrates an S21 parameter of the paired couplers each having the same shape as shown in FIG. 15 and being offset to each other.

FIG. 21 illustrates conditions for simulating a coupling between paired couplers being rotated to each other.

FIG. 22 illustrates an S21 parameter of the paired couplers each having the same shape as shown in FIG. 15 and being rotated to each other.

FIG. 23 illustrates an exemplary coupler of an embodiment.

FIG. 24 schematically illustrates a coupling between paired couplers each having a same shape as shown in FIG. 23 and being offset to each other.

FIG. 25 illustrates an S21 parameter of the paired couplers each having the same shape as shown in FIG. 15 and being offset to each other, and an S21 parameter of the paired couplers each having the same shape as shown in FIG. 23 and being offset to each other.

FIGS. 26A-26D illustrate modifications of the coupler shown in FIG. 15.

FIG. 27 is a block diagram for illustrating a wireless communication device which uses the coupler of the embodiment.

### DETAILED DESCRIPTION

An advantage of an embodiment is to provide a coupler which can be steadily and strongly coupled with an opposite coupler even if one of the couplers is offset or rotated with respect to the other.

According to an embodiment, a coupler is provided on a printed board including a feeder circuit and a grounded circuit. The coupler includes a first line, a short-circuited line and an open-ended line. The first line has two ends. One of the ends is a feed point of the coupler connected to the feeder circuit, and another one of the ends is a node of the coupler. The short-circuited line is extended from the node to an end short-circuited to the grounded circuit. The open-ended line is extended from the node.

Embodiments of the present invention will be described below with reference to the drawings. In order that a close-proximity communication system is used, paired couplers for transmitting and receiving signals need to be put close to each other. An ordinary user manually positions one or both of the couplers. Thus, the paired couplers for transmitting and receiving signals are not necessarily coupled with each other in an optimized relative position. The one coupler can possibly be put, e.g., in a rotated or offset state with respect to the other coupler. Coupling strength in various shape and arrangement conditions will be examined as follows.

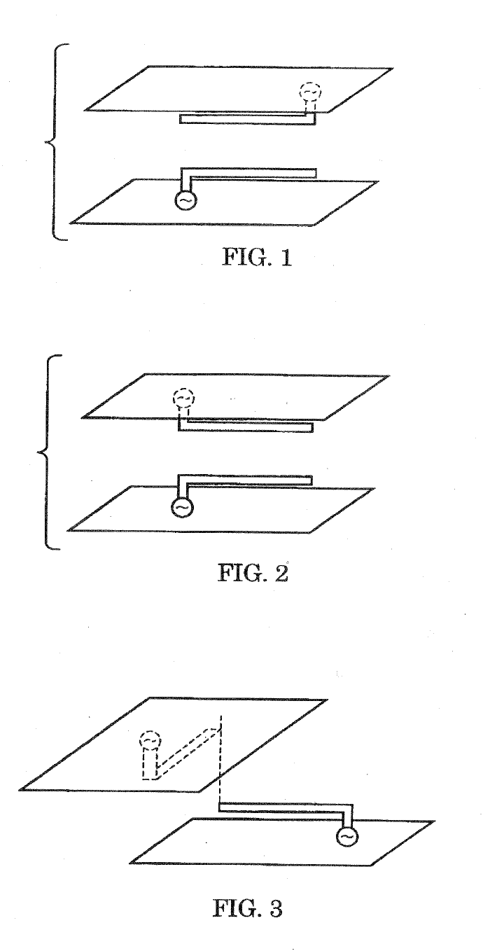

To begin with, assume that each of paired couplers for transmitting and receiving signals is constituted by an open-ended line extended from a feed point provided on a grounded board and having a resonant frequency of f0. If the coupler is excited, a current of a larger amplitude is distributed (coming close to the crest of the current amplitude) on a portion of the coupler closer to the feed point, and a current of a smaller amplitude is distributed (coming close to the trough of the current amplitude) on a portion of the coupler closer to the end. FIG. 1 illustrates an arrangement for making the paired couplers strongly coupled with each other. Incidentally, couplers on upper and lower sides of each of the drawings may be called first and second couplers, respectively, hereafter. In FIG. 1, e.g., the crest of the current amplitude of the first coupler and the trough of the current amplitude of the second coupler are close to each other, and so are the trough of the current amplitude of the first coupler and the crest of the current amplitude of the second coupler. Further, if the direction of the coupler is defined as the direction from the feed point to the open end, the directions of the first and second couplers are opposite. In such a relative position, the paired couplers are strongly coupled with each other in a frequency band around the resonant frequency f0.

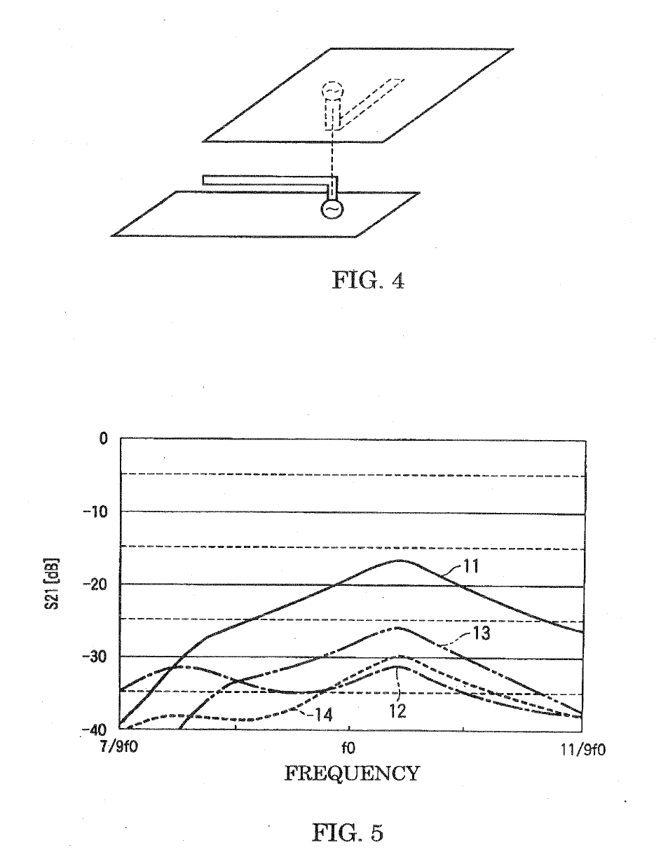

If the first coupler is rotated by 180 degrees with respect to the midpoint of the line in FIG. 1, e.g., the paired couplers are arranged as shown in FIG. 2. In FIG. 2, e.g., the crest of the current amplitude of the first coupler and the crest of the current amplitude of the second coupler are close to each other, and so are the trough of the current amplitude of the first coupler and the trough of the current amplitude of the second coupler. The directions of the first and second couplers are equal. In such a relative position, the paired couplers are very weakly coupled with each other. If the first coupler is rotated by 270 (or 90) degrees with respect to the open end or the feed point, the paired couplers are arranged as shown in FIG. 3 or FIG. 4. In FIGS. 3 and 4, e.g., as the directions of the first and second couplers are perpendicular to each other, it is expected that their mutual coupling is stronger in FIGS. 3 and 4 than in FIG. 2, and is weaker than in FIG. 1.

FIG. 5 illustrates S21 parameters corresponding to FIGS. 1-4 estimated by means of simulations. To put it specifically, the S21 parameters corresponding to FIGS. 1-4 are represented by curves 11, 12, 13 and 14, respectively. As obviously shown in FIG. 5, the coupling is strongest and weakest in FIG. 1 and in FIG. 2, respectively.

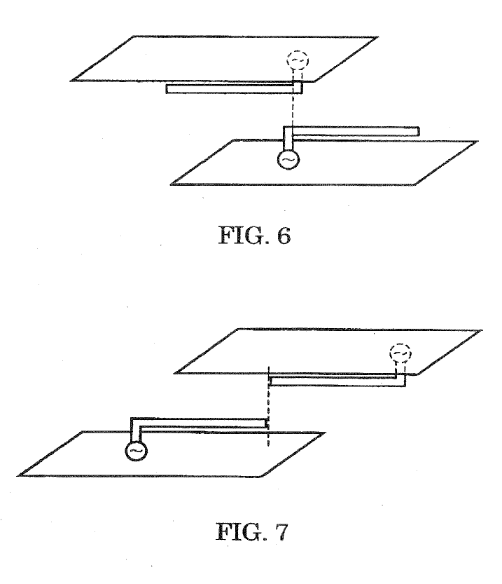

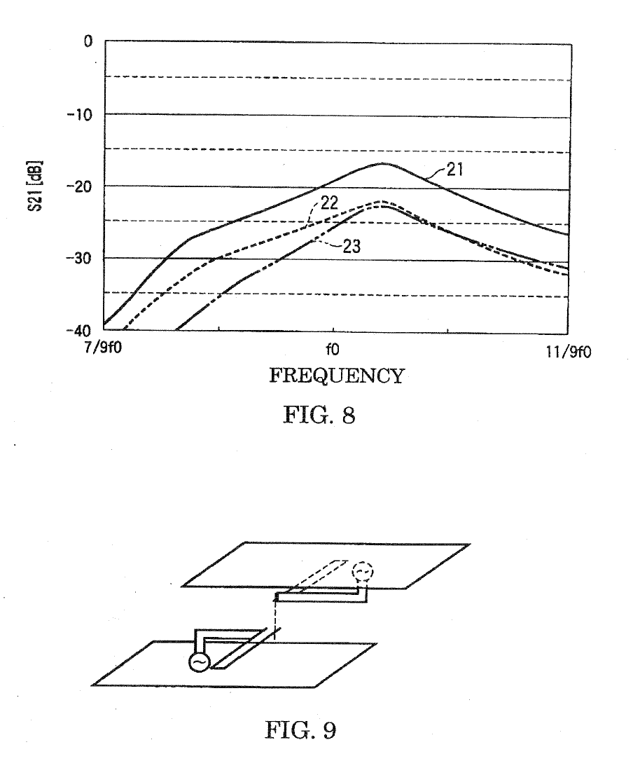

If the first coupler is offset in FIG. 1, e.g., the paired couplers are arranged as shown in FIG. 6 or FIG. 7. As the first and second couplers are more distant from each other in FIGS. 6 and 7 than in FIG. 1, it is expected that their mutual coupling is weaker in FIGS. 6 and 7 than in FIG. 1. FIG. 8 illustrates S21 parameters corresponding to FIGS. 1, 6 and 7 estimated by means of simulations. To put it specifically, the S21 parameters corresponding to FIGS. 1, 6 and 7 are represented by curves 21, 22 and 23, respectively. As obviously shown in FIG. 8, the first and second couplers are coupled with each other strongly, although a bit less strongly than the arrangement shown in FIG. 1.

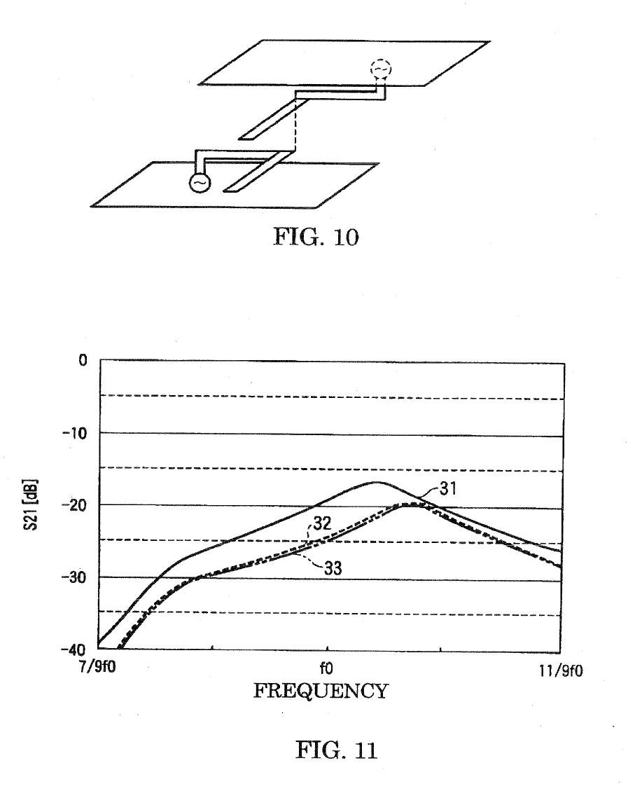

If the lines of the first and second couplers of the shapes and arrangements shown in FIG. 1 are bent around their respective midpoints in such a way that their open ends are directed in opposite directions, the paired couplers are shaped and arranged as shown in FIG. 9. Meanwhile, if the lines of the first and second couplers of the shapes and arrangements shown in FIG. 1 are bent around their respective midpoints in such a way that their open ends are directed in a same direction, the paired couplers are shaped and arranged as shown in FIG. 10. If the coupler is excited in FIG. 9 or in FIG. 10, a current of larger amplitude is distributed on a portion of the coupler closer to the feed point, and a current of smaller amplitude is distributed on a portion of the coupler closer to the end. FIG. 11 illustrates S21 parameters corresponding to FIGS. 1, 9 and 10 estimated by means of simulations. To put it specifically, the S21 parameters corresponding to FIGS. 1, 9 and 10 are represented by curves 31, 32 and 33, respectively. As obviously shown in FIG. 11, the first and second couplers are coupled with each in FIG. 10 approximately as strongly as they are in FIG. 9. It is thereby conceivable that the direction of the portion of the smaller current amplitude affects the strength of the coupling not so much as the direction of the portion of the larger current amplitude.

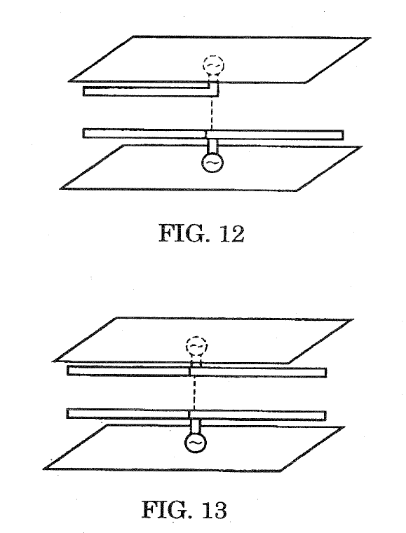

If the second coupler shown in FIG. 2 is provided with an additional line, the paired couplers are shaped and arranged as shown in FIG. 12. The additional line is open-ended and extended in an opposite direction with respect to the original line. If the second coupler is excited, a current of a larger amplitude is distributed (coming close to the crest of the current amplitude) on a portion of the second coupler closer to the feed point, and currents of smaller amplitudes are distributed (coming close to the trough of the current amplitude) on portions of the second coupler closer to the ends of the original and additional lines. The exemplary relative position between the line of the first coupler and the original line of the second coupler shown in FIG. 12 is similar to the example shown in FIG. 2. Meanwhile, the exemplary relative position between the line of the first coupler and the additional line of the second coupler shown in FIG. 12 is similar to the example shown in FIG. 6. Further, if the first coupler is rotated by 180 degrees with respect to the feed point, the first and second couplers are in a similar relative position. Thus, it is expected that their mutual coupling is stronger in FIG. 12 than in FIG. 2.

Further, if the first coupler shown in FIG. 12 is provided with an additional line similarly as the second coupler, the paired couplers are shaped and arranged as shown in FIG. 13. The exemplary relative position between the original line of the first coupler and the original line of the second coupler shown in FIG. 13 is similar to the example shown in FIG. 2. The exemplary relative position between the original line of the first coupler and the additional line of the second coupler shown in FIG. 13 is similar to the example shown in FIG. 6. Meanwhile, the relative position between the additional line of the first coupler and the original line of the second coupler shown in FIG. 13 is similar to the example shown in FIG. 6. The relative position between the additional line of the first coupler and the additional line of the second coupler shown in FIG. 13 is similar to the example shown in FIG. 2. Further, if the first coupler is rotated by 180 degrees with respect to the feed point, the first and second couplers are in a similar relative position. Thus, it is expected that their mutual coupling is stronger in FIG. 13 than in FIG. 2.

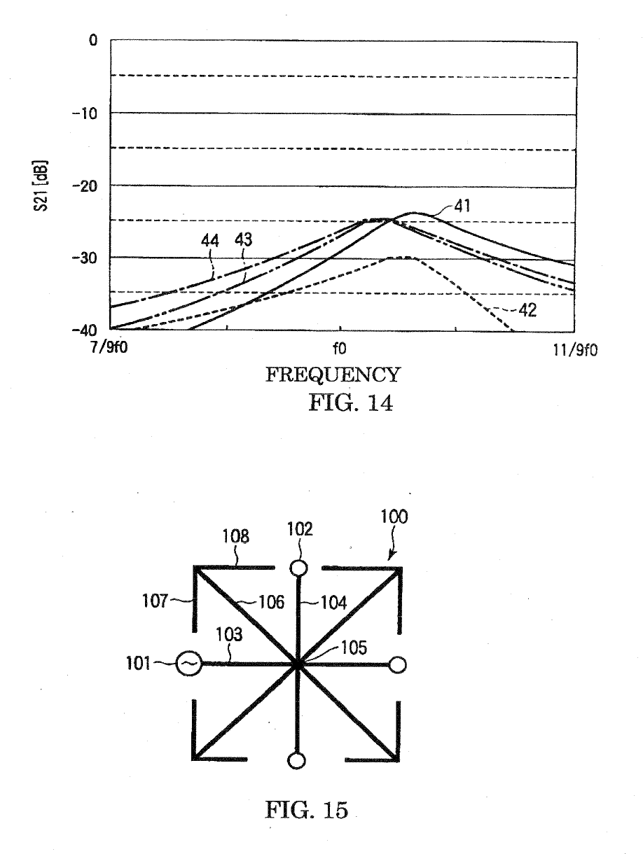

FIG. 14 illustrates S21 parameters corresponding to FIGS. 6, 2, 12 and 13 estimated by means of simulations. To put it specifically, the S21 parameters corresponding to FIGS. 6, 2, 12 and 13 are represented by curves 41, 42, 43 and 44, respectively. As obviously shown in FIG. 14, the coupling between the paired couplers is stronger in the relative positions shown in FIGS. 12 and 13 than in the relative position shown in FIG. 2.

A configuration of the paired couplers which can be steadily and strongly coupled with each other even if the one of them is offset or rotated with respect to the other will be studied on the basis of the above examinations. To begin with, it is assumed that the crest and trough of the current distribution of the one of the couplers are arranged close to the trough and crest of the current distribution of the other of the couplers, respectively. The direction from the feed point to the open end of the line of the coupler is defined as the line direction. In this case, it is conceivably important for strong coupling that the line directions of the paired couplers be opposite each other. That is, it is desirable to maintain such a good relative position between the paired couplers even in case of offsetting or rotation. The coupler can be conceivably formed by a plurality of lines radially extended from one point so as to maintain the good relative position between the paired couplers. If the one of the couplers configured in such a way is rotated with respect to the convergent point of the lines, one of the radially provided lines can probably be in a good relative position with respect to the other one of the couplers similarly as in FIGS. 1, 6, 7, 12 and 13. Further, if the one of the couplers is offset, one of the radially provided lines can probably be in a good relative position with respect to the other one of the couplers similarly as in FIGS. 1, 6 and 7. Further, it is conceivably desirable to provide one or more short-circuit point(s) so as to increase input impedance. Further, the feed point and the short-circuit point(s) should be provided around the end of the coupler from a viewpoint of assembly (wiring in particular). Further, it is conceivably desirable that the shape of the paired couplers be symmetrical with respect to the convergent point of the lines.

The configuration of the coupler of the embodiment will be described in general as follows. The coupler of the embodiment has one feed point at a position corresponding to a vertex of a polygon (desirably a regular polygon) and one or more short-circuit point(s) at a position corresponding to another vertex (positions corresponding to other vertices). The coupler has, e.g., one feed point at a position corresponding to a vertex of a square, and three short-circuit points at positions corresponding to the remaining three vertices. Incidentally, the feed point and the short-circuit point(s) should be provided around end portions of the coupler from a viewpoint of assembly. That is, it is desirable that the vertices of the polygon be each in contact with the respective end portions of the coupler. The coupler has a plurality of lines extended from the feed point and the short-circuit point(s) to a gravity center of the polygon. These lines cross at a node provided at a position corresponding to the gravity center. Further, the coupler can further have a plurality of crossing lines extended from the node. It is desirable that the plural crossing lines be extended radially from the node. One of the crossing lines can be extended in such a way as to equally divide an angle between two of the lines extended from the feed point or the short-circuit point to the node so as to make the shape of the coupler symmetrical with respect to the node. In this case, the positions of the feed point and the adjacent short-circuit point are symmetrical with respect to the corresponding crossing line. Further, the positions of adjacent two of the short-circuit points are symmetrical with respect to the corresponding crossing line. Further, a branch line can further be extended from a tip of each of the crossing lines. The branch line is extended straight or in curve from the tip of the crossing line towards the feed point or the short-circuit point. It is desirable that a total electric length from the feed point or the short-circuit point, via the fine, the node, the crossing line (or further the branch line) and to an end portion be a quarter wavelength of a carrier wave of the coupler multiplied by an integer.

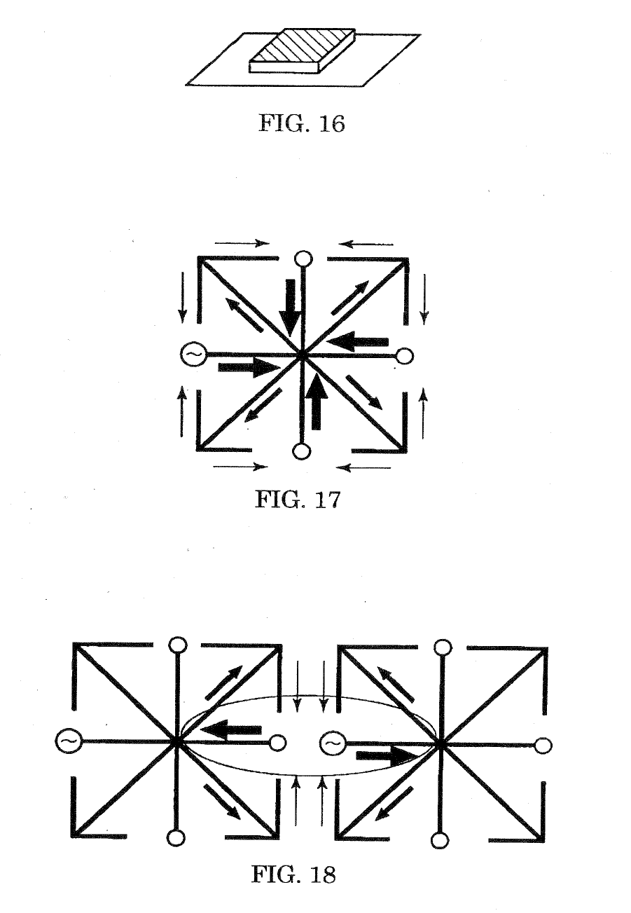

FIG. 15 illustrates an exemplary coupler of the embodiment. The coupler 100 shown in FIG. 15 includes a feed point 101 arranged at a position corresponding to a vertex of a square on a grounded board, and three short-circuit points 102, etc. arranged at positions corresponding to the remaining vertices of the square. The coupler 100 includes a line 103 extended from the feed point 101 to a gravity center of the square, and three lines 104, etc. extended from the respective three short-circuit points to the gravity center of the square. The coupler 100 includes four crossing lines 106, etc. extended from a node 105 at which the above four lines meet. The coupler 100 includes branch lines 107, 108, etc. further extended from tips of the respective four crossing lines. Incidentally, a total electric length from the feed point 101 or the short-circuit point 102, etc., via the line (103, 104, etc.), the node 105, the crossing line (106, etc.), the branch line (107, 108, etc.) and to an end portion is a quarter wavelength of a carrier wave of the coupler 100 multiplied by an integer. Incidentally, FIG. 15 shows a wiring pattern printed on a surface of the coupler put on the grounded board as shown in FIG. 16.

FIG. 17 shows a direction of each of the lines defined as a direction from the feed point or the short-circuit point to the open end. Incidentally, an arrow schematically shows the direction of the line and an amplitude of a current which flows on the line. To put it specifically, a current distribution on the coupler 100 is such that a current of a larger amplitude is distributed on a portion of the coupler closer to the feed point 101 or the short-circuit point, and a current of a smaller amplitude is distributed on a portion of the coupler closer to the end. Incidentally, the current distribution on the coupler 100 is substantially symmetrical with respect to the node. Paired couplers each having the same shape as the coupler 100 are coupled with each other while being offset to each other, e.g., as shown in FIG. 18. As shown in FIG. 18, e.g., the short-circuit point of the one coupler and the feed point of the other coupler are put close to each other. That is, the line of the one coupler from the short-circuit point to the node and the line of the other coupler from the feed point to the node are relatively positioned similarly as shown in FIG. 6. Both the lines support large current amplitudes and are directed opposite. It is thereby expected that the paired couplers each having the same shape as the coupler 100 be steadily and strongly coupled with each other even while being offset to each other.

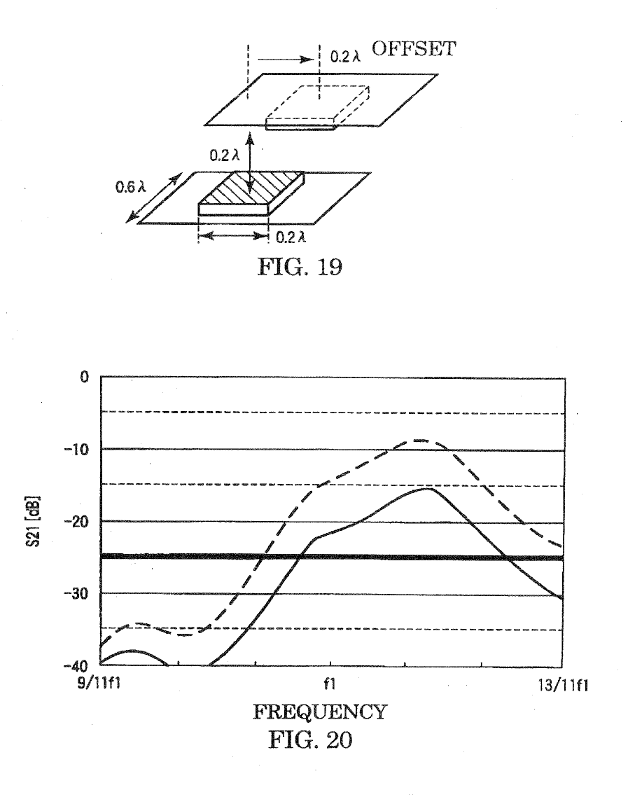

FIG. 19 illustrates exemplary conditions for simulating a coupling between paired couplers being offset to each other. To put it specifically, the coupler is designed so as to be resonant in a frequency band around f1 (wavelength ?) in accordance with the simulation conditions. The coupler is set to around 0.2? square in size and around 0.02? thick, a distance between the couplers (in the vertical direction) is set to around 0.2? and an offset distance (in the horizontal direction) is set to around 0.2?. Further, it is assumed that the paired couplers are of a same shape. An S21 parameter of the paired couplers each having the same shape as the coupler 100 was analyzed in the simulation conditions described above as shown in FIG. 20, where dotted and solid lines represent S21 parameters in regular (no offset) and offset positions, respectively. It is shown in FIG. 20 that the S21 values increase in the frequency band around f1, and that the paired couplers are strongly coupled with each other.

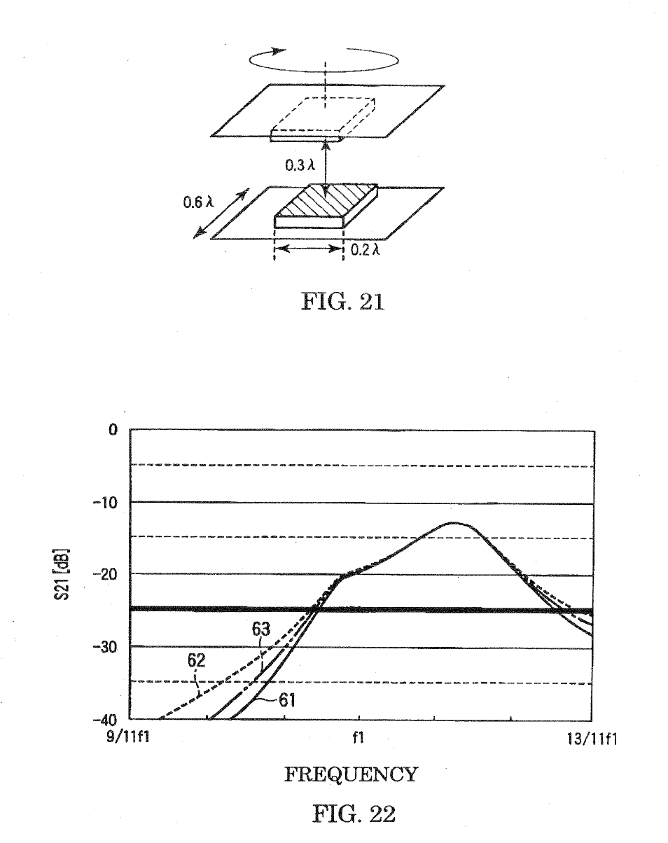

FIG. 21 illustrates exemplary conditions for simulating a coupling between paired couplers being rotated to each other. To put it specifically, the coupler is set to around 0.2? square in size and around 0.02? thick, and a distance between the couplers (in the vertical direction) is set to around 0.2?. Further, it is assumed that the paired couplers are of a same shape. An S21 parameter of the paired couplers each having the same shape as the coupler 100 was analyzed in the simulation conditions described above. The one coupler is rotated with respect to the center of the other coupler by certain degrees (called the rotation angle hereafter) for the simulation. In FIG. 22, curves 61-63 represent S21 parameters at rotation angles of 0 (no rotation), 180 and 90 (or 270) degrees, respectively. As obviously shown in FIG. 22, the S21 parameters of the paired couplers rotated by every 90 degrees vary less in the frequency band around f1, where the paired couplers are steadily and strongly coupled with each other.

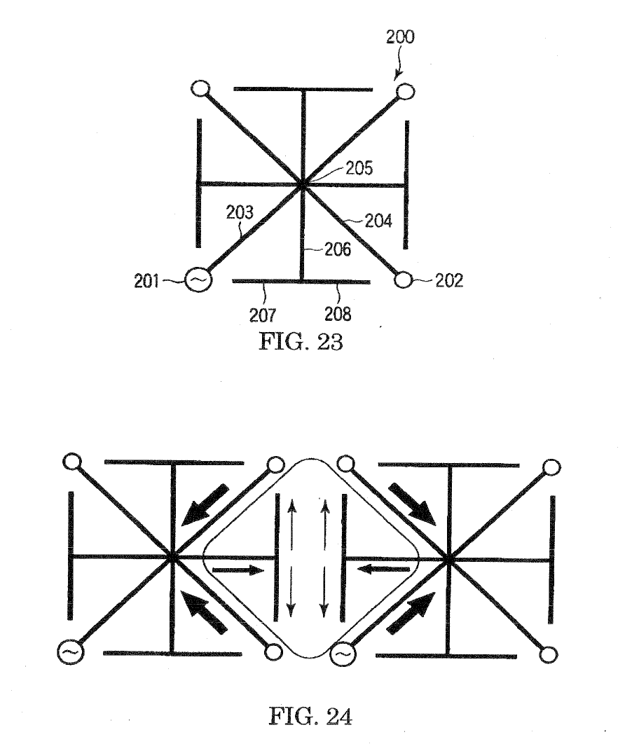

FIG. 23 illustrates another exemplary coupler of the embodiment. The coupler 200 shown in FIG. 23 includes a feed point 201 arranged at a position corresponding to a vertex of a square on a grounded board, and three short-circuit points 202, etc. arranged at positions corresponding to the remaining vertices of the square. The coupler 200 includes a line 203 extended from the feed point 201 to a gravity center of the square, and three lines 204, etc. extended from the respective three short-circuit points to the gravity center of the square. The coupler 200 includes four crossing lines 206, etc. extended from a node 205 at which the above four lines meet. The coupler 200 includes branch lines 207, 208, etc. further extended from tips of the respective four crossing lines. Incidentally, a total electric length from the feed point 201 or the short-circuit point 102, etc., via the line (203, 204, etc.), the node 205, the crossing line (206, etc.), the branch line (207, 208, etc.) and to an end portion is a quarter wavelength of a carrier wave of the coupler 200 multiplied by an integer. Incidentally, FIG. 23 shows a wiring pattern printed on a surface of the coupler put on the grounded board as shown in FIG. 16.

A current distribution on the coupler 200 is such that a current of a larger amplitude is distributed on a portion of the coupler closer to the feed point 201 or the short-circuit point, and a current of a smaller amplitude is distributed on a portion of the coupler closer to the end. Incidentally, the current distribution on the coupler 200 is substantially symmetrical with respect to the node. Paired couplers each having the same shape as the coupler 200 are coupled with each other while being offset to each other, e.g., as shown in FIG. 24. As shown in FIG. 24, e.g., the tip of the crossing line of the one coupler and the tip of the crossing line of the other coupler are put close to each other. That is, both the lines are relatively positioned similarly as shown in FIG. 7 described above. Both the lines support large current amplitudes and their directions from the feed points to the open ends are opposite. It is thereby expected that the paired couplers each having the same shape as the coupler 200 be steadily and strongly coupled with each other even while being offset to each other.

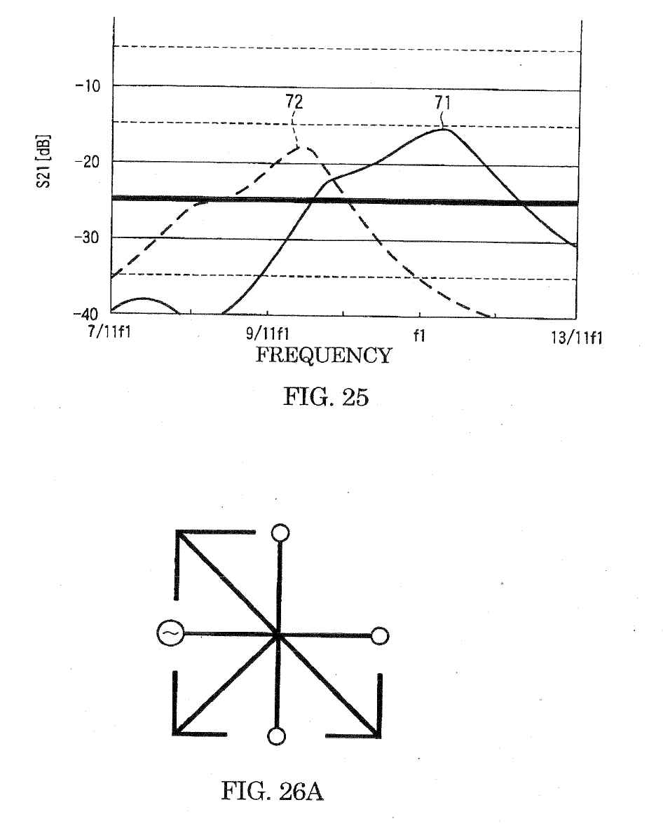

An S21 parameter of the paired couplers each having the same shape as the coupler 200 was measured in the simulation conditions shown in FIG. 19 while the paired couplers were being offset to each other. In FIG. 25, curves 71 and 72 represent S21 parameters of the paired couplers each having the same shape as the coupler 100 and of the paired couplers each having the same shape as the coupler 200, respectively. Upon being coupled with a coupler of the same shape, as obviously shown in FIG. 25, the coupler 200 is resonant in a lower frequency band than the coupler 100, and is strongly coupled in that frequency band.

As described above, the coupler of the embodiment has a plurality of lines radially extended from one point. Thus, one of the plural lines of the coupler of the embodiment can probably be in a good relative position with respect to an opposite coupler, and can be steadily and strongly coupled with the opposite coupler. The coupler of the embodiment can also be strongly coupled with a standard coupler of an electric field coupling type, and with a coupler of a magnetic field coupling type of the same shape.

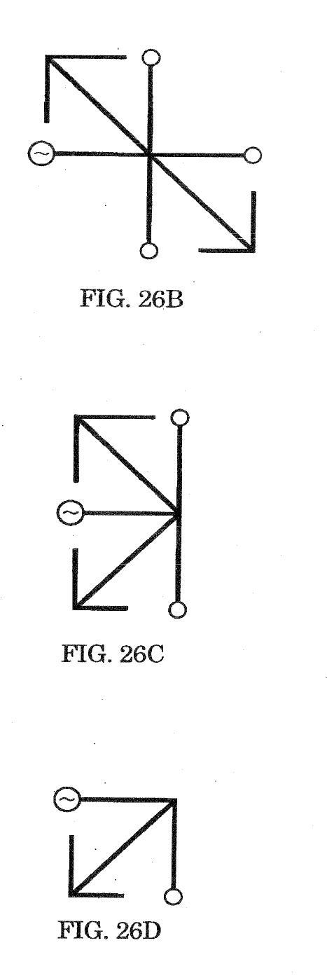

Incidentally, the coupler of the embodiment can partially enjoy above advantages even if some of the portions of the exemplary shapes described above are removed. As shown in FIG. 26A, e.g., one crossing line and the corresponding branch lines can be removed from the coupler 100. As shown in FIG. 26B, one crossing line and the corresponding branch lines can further be removed from the coupler shown in FIG. 26A. As shown in FIG. 26C, one short-circuit point and the corresponding line, and one crossing line and the corresponding branch lines can further be removed from the coupler shown in FIG. 26A. As shown in FIG. 26D, one short-circuit point and the corresponding line, and one crossing line and the corresponding branch lines can further be removed from the coupler shown in FIG. 26C. The coupler can be easily downsized by means of the removal of such portions.

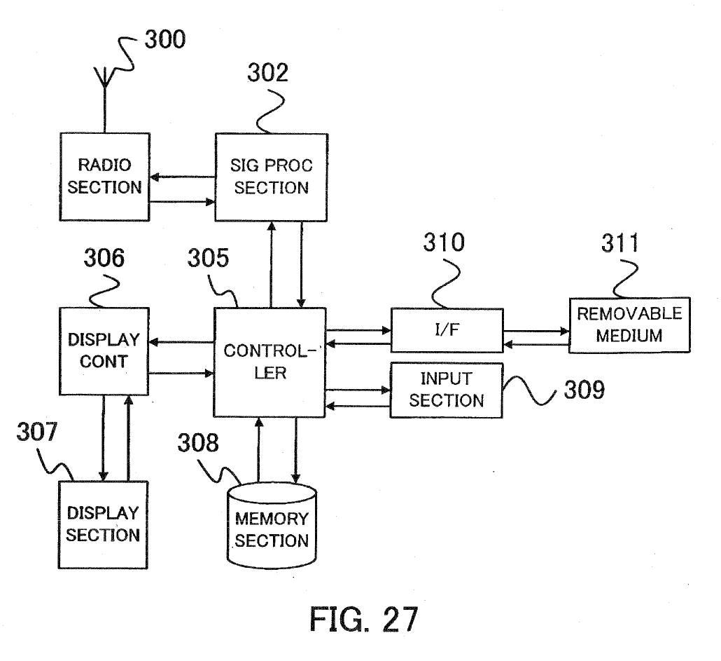

Further, the coupler of the embodiment can be used in, e.g., a wireless communication device (e.g., a mobile phone, a PC, etc.) shown in FIG. 27 for transmitting and receiving radio signals. The wireless communication device shown in FIG. 27 has an antenna 300, a radio section 301, a signal processing section 302. a controller 305, a display controller 306, a display section 307, a memory section 308, an input section 309, an I/F 310 and a removable medium 311.

The antenna 300 is constituted by the coupler of the embodiment. The antenna 300 carries out close-proximity wireless communication such as TransferJet by means of a magnetic coupling. The radio section 301 works as directed by the controller 305, up-converts a transmission signal provided by the signal processing section 302 into a radio frequency band so as to transmit the transmission signal to an opposite antenna (coupler), receives a radio signal sent from the opposite antenna via the antenna 300 and down-converts the received signal into a baseband signal.

The signal processing section 302 modulates a carrier wave by using transmission data provided by the controller 305 so as to produce the transmission signal, demodulates the baseband signal provided by the radio section 301 so as to obtain received data and provides the controller 305 with the received data. The controller 305 has a processor such as a CPU, and supervises every component of the communication device shown in FIG. 27.

The memory section 308 is constituted by memory media such as a RAM (Random Access Memory), a ROM (Read Only Memory) and a hard disk, in which a control program and control data of the controller 305, various data made by a user, control data concerning the removable medium 311 and so on are stored. The display controller 306 drives and controls the display section 307 as directed by the controller 305, and displays on the display section 307 an image signal based on display data provided by the controller 305. The input section 309 includes a user interface which accepts a user's request by using an input device such as a plurality of key switches (e.g., so called ten keys (numeric keypad)) or a touch panel. The interface (I/F) 310 is an interface for physically and electrically connecting the removable medium 311 for data exchange, and is controlled by the controller 305.

The wireless communication device shown in FIG. 27 transmits content data, e.g., stored in the memory section 308 or the removable medium 311, to an opposite device by means of the close-proximity wireless communication means, stores content data received from the opposite device by means of the close-proximity wireless communication means in the memory section 308 or the removable medium 311, and displays the content data on the display section 307.

Incidentally, the present invention is not limited to the above embodiment as it is, and can be implemented in a practical phase by including modifications of the components within the scope of the present invention. Further, a plurality of the components disclosed for the above embodiment can be properly combined, so that various inventions can be formed. Further, e.g., a configuration in which some of the components of the embodiment are removed is conceivable.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A coupler provided on a printed board, the printed board including a feeder circuit and a grounded circuit, comprising:
a first line having two ends, one of the ends being a feed point of the coupler connected to the feeder circuit, another one of the ends being a node of the coupler;
a short-circuited line extended from the node to an end short-circuited to the grounded circuit; and
an open-ended line extended from the node.

2. The coupler according to claim 1, further comprising a branch line branching off from the open-ended line.

3. The coupler according to claim 1, wherein the first line and the second line are arranged line-symmetrical with respect to a portion of the third line including the node.

4. The coupler according to claim 1, further comprising:
at least one additional short-circuited line extended from the node to an end short-circuited to the grounded circuit; and
at least one additional open-ended line extended from the node.

5. The coupler according to claim 1, further comprising:
at least one additional short-circuited line extended from the node to an end short-circuited to the grounded circuit; and
at least one additional open-ended line extended from the node, wherein
the coupler is shaped line-symmetrical as a whole.

6. The coupler according to claim 1, further comprising:
at least one additional short-circuited line extended from the node to an end short-circuited to the grounded circuit; and
at least one additional open-ended line extended from the node, wherein
the coupler is shaped point-symmetrical with respect to the node as a whole.

7. A coupler provided on a printed board, the printed board including a feeder circuit and a grounded circuit, comprising:
a feed point arranged at a position corresponding to a first vertex of a polygon on the printed board, the feed point being connected to the feeder circuit;
a short-circuit point arranged at a position corresponding to a second vertex of the polygon on the printed board, the short-circuit point being connected to the grounded circuit;
a first line extended from the feed point to a gravity center of the polygon;
a short-circuit line extended from the short-circuit point to the gravity center of the polygon, the first line and the second line crossing at a node; and
an open-ended line extended from the node.

8. The coupler according to claim 7, wherein:
the feeder circuit operates at an operation frequency; and
a sum of electric lengths of the first line and the open-ended line substantially equals a quarter wavelength of the operation frequency multiplied by an integer.

9. The coupler according to claim 7, wherein:
the feeder circuit operates at an operation frequency; and
a sum of electric lengths of the short-circuit line and the open-ended line substantially equals a quarter wavelength of the operation frequency multiplied by an integer.

10. The coupler according to claim 7, further comprising a branch line branching off from the open-ended line, wherein:
the feeder circuit operates at an operation frequency; and
an electric length between the feed point and an end of the branch line, via the first, open-ended and branch lines, substantially equals a quarter wavelength of the operation frequency multiplied by an integer.

11. The coupler according to claim 7, further comprising a branch line branching off from the third line, wherein:
the feeder circuit operates at an operation frequency; and
an electric length between the short-circuit point and an end of the branch line, via the short-circuit, open-ended and branch lines, substantially equals a quarter wavelength of the operation frequency multiplied by an integer.

12. The coupler according to claim 7, wherein the short-circuit point and the feed point are arranged line-symmetrically with respect to the open-ended line.

13. The coupler according to claim 7, further comprising:
at least one additional short-circuit point arranged at a position corresponding to a vertex of the polygon other than the first and second vertices;
an additional short-circuit line extended from the additional short-circuit point to the node; and
an additional open-ended line extended from the node;

14. A wireless communication device, comprising:
a coupler provided on a printed board, the printed board including a feeder circuit and a grounded circuit, the coupler including a feed point arranged at a position corresponding to a first vertex of a polygon on the printed board, the feed point being connected to the feeder circuit, the coupler including a short-circuit point arranged at a position corresponding to a second vertex of the polygon on the printed board, the short-circuit point being connected to the grounded circuit, the coupler including a first line extended from the feed point to a gravity center of the polygon, the coupler including a short-circuit line extended from the short-circuit point to the gravity center of the polygon, the first line and the second line crossing at a node, the coupler including an open-ended line extended from the node;
a radio section which up-converts a baseband transmission signal into a radio transmission signal to be transmitted via the coupler, the radio section being configured to down-converts a radio received signal received via the coupler into a baseband received signal; and
a signal processing section which processes the baseband transmission signal and the baseband received signal.
